(19) United States
(12) Patent Application Publication
(10) Pub. No.: US 2021/0026364 A1
(43) Pub. Date: Jan. 28, 2021

(54) MOBILE ROBOT AND CONTROLLING METHOD THEREOF

(71) Applicant: LG ELECTRONICS INC., Seoul (KR)

(72) Inventors: Yongmin SHIN, Seoul (KR); Ilsoo CHO, Seoul (KR); Juno CHOI, Seoul (KR)

(73) Assignee: LG ELECTRONICS INC., Seoul (KR)

(21) Appl. No.: 16/981,441

(22) PCT Filed: Mar. 15, 2019
(86) PCT No.: PCT/KR2019/003030

§ 371 Date: Sep. 16, 2020

(30) Foreign Application Priority Data
Mar. 16, 2018 (KR) 10-2018-0030748

(51) Int. Cl. G05D 1/02; A47L 9/28

(52) U.S. Cl. CPC G05D 1/0225; G05D 1/0246; G05D 1/0274; A47L 9/2873; A47L 2201/04; A47L 9/2894; G05D 2201/0215; A47L 2201/022; A47L 9/2852

(57) ABSTRACT

A mobile robot and a controlling method thereof of the present disclosure includes: a main body which travels in an area; a tool mounted at the main body to assist n cleaning; a holder onto which the tool is held; and a charging stand which supplies operating power to move the main body, wherein when the tool becomes separated from the holder, upon receiving a tool separation signal from the charging stand, the main body moves to a position of the tool so that the tool may be mounted at the main body. Accordingly, when the tool becomes separated, the mobile robot may detect a position of a user based on a map, and may move upon recognizing a user having the tool, without requiring the user to move, thereby enabling the user to mount the tool and designate an operation in a convenient manner.

### TECHNICAL FIELD

The present disclosure relates to a mobile robot and a controlling method thereof, and more particularly to a mobile robot, which returns to a charging stand while traveling in an area. to be cleaned, and a controlling method thereof.

### BACKGROUND

Generally, a mobile robot is a home appliance that automatically performs cleaning by sucking foreign substances, such as dust and the like, from a floor while travelling autonomously in an area to be cleaned without a user's manipulation.

The mobile robot senses a distance to an obstacle such as furniture, office supplies, walls, and the like, which are installed in an area to be cleaned, and performs an operation to avoid the obstacles. The mobile robot includes an obstacle detection unit to sense obstacles, located within a predetermined distance, to avoid the obstacles. Further, if a battery requires charging, the mobile robot may return to a charging stand to charge the battery, and then may perform again a designated operation. Recently, such mobile robot provides various additional functions, ranging from a method using a camera function to a function of sucking dust and wet cloth cleaning on the surface at the same time. With the addition of new functions, the mobile robot is equipped with cleaning tools.

However, as the cleaning tools are not attached to the mobile robot all the time, there may be a problem of storing the tools. As the types of tools are increased, they are difficult to manage and may be lost. In order to solve the problem, a holder for storing the tools may be provided, but the holder simply functions as a stand and provides no additional function

### SUMMARY

### Technical Problem

It is an object of the present disclosure to provide a mobile robot and a controlling method thereof, in which a charging stand and a holder may communicate with each other sense separation of a tool, such that the mobile robot may move to a position for mounting the separated tool, or may move by determining a position of the tool.

### Technical Solution

In accordance with one aspect of the present disclosure, there is provided a mobile robot, including: a main body which travels in an area; a tool mounted at the main body to assist in cleaning; a holder onto which the tool is held; and a charging stand which supplies operating power to move the main body, wherein when the tool becomes separated from the holder, upon receiving a tool separation signal from the charging stand, the main body moves to a position of the tool so that the tool is mounted at the main body.

The main body may include: a detection unit configured to detect an obstacle in a traveling direction; a communicator configured to receive a signal from the charging stand or the tool; a data unit configured to store a plurality of image data and obstacle data, which are input from the detection unit; and a controller configured to recognize an obstacle based on data input from the detection unit, and upon receiving through the communicator the tool separation signal from the charging stand or a tool position signal from the tool, configured to control traveling to move to the charging stand or the tool

Upon receiving the tool separation signal while a battery is charged at the charging station, the controller may control a traveling unit to become separated from the charging stand and to move a predetermined distance.

Upon receiving the tool separation signal while traveling, the controller may control the traveling unit to move to the charging stand.

Once the detection unit senses a human body while moving to the charging stand, the controller may recognize that the sensed human body has the tool, and may control the traveling unit to approach the human body.

The tool may include a communication module for transmitting a position signal, wherein upon receiving a tool position signal from the user, the controller may track the tool position signal, to move to a position of the tool.

Upon receiving the tool separation signal, the controller may move in areas sequentially based on a pre-stored map, to detect whether a user or a tool is located in the areas. The controller may move to a center of each area, and may rotate at the center to detect whether the user is located in each area.

Upon approaching any one of a sensed human body, the tool, and the charging stand by a predetermined distance, the main body may output guidance on mounting of the tool, and upon determining whether it is required to rotate at a position to mount the tool, the main body may rotate by a predetermined angle so that the tool may be mounted.

The main body may wait for a predetermined period of time to sense whether the tool is mounted, wherein when the tool is mounted, the main body may perform a predetermined operation, and when the tool is not mounted within a predetermined time, the main body may re-detect the tool or may return to a previous position.

Further, the mobile robot includes: a main body which travels in an area; a communication module configured to transmit a position signal; a tool mounted at the main body to assist in cleaning; a holder onto which the tool is held; and a charging stand which supplies operating power to move the main body, wherein when the tool becomes separated from the holder, the tool transmits the position signal; and upon receiving the position signal from the tool, the main body tracks the position signal to move to a position of the tool.

In accordance with another aspect of the present disclosure, there is provided a controlling method of a mobile robot, the method including: separating a tool, held onto a holder, from the holder; transmitting a tool separation signal of the tool from the holder to a charging stand; transmitting the tool separation signal from the charging stand to a main body of the mobile robot; by the main body, receiving the tool separation signal; and by the main body, moving to a position of the tool so that the tool is mounted at the main body.

The controlling method of a mobile robot may further include, upon receiving the tool separation signal while a battery is charged at the charging station, separating from the charging stand and moving a predetermined distance.

The controlling method of a mobile robot may further include, upon receiving the tool separation signal while traveling, moving to the charging stand.

The controlling method of a mobile robot may further include, upon sensing a human body while moving to the charging stand, recognizing that the sensed human body has the tool, and approaching the human body.

The controlling method of a mobile robot may further include, upon receiving the tool separation signal, moving in a plurality of areas sequentially based on a pre-stored map; and detecting a human body or the tool located in each area.

The controlling method of a mobile robot may further include: approaching any one of a sensed human body, the tool, and the charging stand by a predetermined distance while the main body moves; outputting guidance on mounting of the tool; and waiting for a predetermined period of time and sensing whether the tool is mounted.

In the mobile robot and controlling method thereof according to the present disclosure, once a tool becomes separated from a holder, the mobile robot may recognize separation of the tool through a charging stand.

In the mobile robot and controlling method thereof according to the present disclosure, separation of the tool may be recognized, and the mobile robot may move to a position that facilitates mounting of the tool, or may change a direction, thereby improving user convenience.

In the mobile robot and controlling method thereof according to the present disclosure, once the tool becomes separated from the holder, the mobile robot may detect a user's position; and upon recognizing a user having the tool, the mobile robot, which travels in another area, may move to the user without requiring the user to detect and move to the mobile robot, thereby enabling the user to mount the tool and designate an operation in a convenient manner.

In the mobile robot and controlling method thereof according to the present disclosure, the tool has a communication function, such that the mobile robot may track a signal transmitted from the tool, and may move to the position of the tool.

### BRIEF DESCRIPTION OF DRAWINGS

FIG. 1 is a perspective view of a mobile robot, including a charging stand and a holder, according to an embodiment of the present disclosure.

FIG. 2 is a diagram illustrating another example of the holder of FIG. 1.

FIG. 3 is a block diagram illustrating principal components of a mobile robot according to an embodiment of the present disclosure.

FIGS. 4A and 4B are diagrams illustrating a signal flow between a mobile robot, a holder, and a charging stand according to an embodiment of the present disclosure.

FIGS. 5A and 5B are diagrams illustrating an operation of a mobile robot in response to sensing separation of a tool according to an embodiment of the present disclosure.

FIG. 6 is a diagram illustrating a traveling operation of a mobile robot in response to sensing separation of a tool according to an embodiment of the present disclosure.

FIGS. 7A-7C are diagrams referred to in explaining a tool detecting method of a mobile robot in response to sensing separation of a tool according to an embodiment of the present disclosure.

FIG. 8 is a diagram referred to in explaining a tool approaching method of a mobile robot based on a tool position signal according to an embodiment of the present disclosure.

FIG. 9 is a flowchart illustrating a controlling method of a mobile robot in response to sensing separation of a tool during battery charging, according to an embodiment of the present disclosure.

FIG. 10 is a flowchart illustrating a controlling method of a mobile robot in response to sensing separation of a tool while the mobile robot travels, according to an embodiment of the present disclosure.

FIG. 11 is a flowchart illustrating a tool detecting method by using a map of a mobile robot and a controlling method thereof according to an embodiment of the present disclosure.

FIG. 12 is a flowchart illustrating a tool detecting method by using a position signal of a mobile robot and a controlling method thereof according to an embodiment of the present disclosure.

### DETAILED DESCRIPTION

Advantages and features of the present disclosure, and a method of achieving the same will be more clearly understood from the following embodiments described in detail with reference to the accompanying drawings. However, the present disclosure is not limited to the following embodiments but may be implemented in various different forms. The embodiments are provided merely to complete disclosure of the present disclosure and to fully provide a person having ordinary skill in the art, to which the present disclosure pertains, with the category of the disclosure. The disclosure is defined only by the category of the claims. Wherever possible, the same reference numbers will be used throughout the specification to refer to the same or like parts. Further, in a mobile robot, a controller and each part may be implemented as one or more processors.

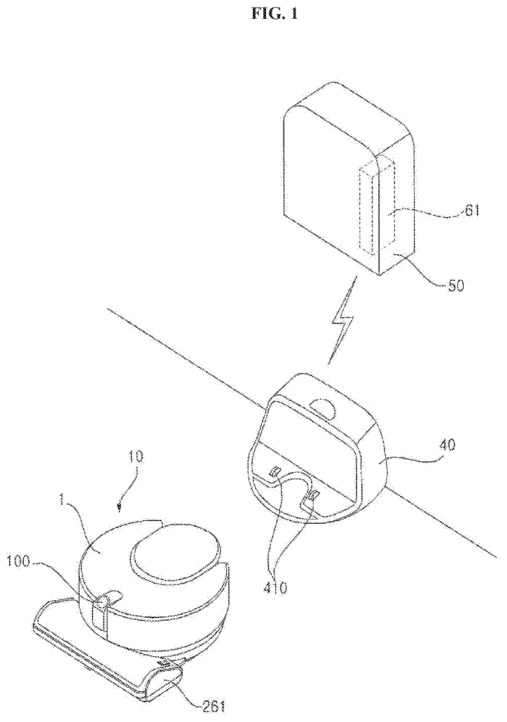

FIG. 1 is a perspective view of a mobile robot, including a charging stand and a holder, according to an embodiment of the present disclosure.

Referring to FIG. 1, the mobile robot 1 according to an embodiment of the present disclosure includes: a main body 10 which travels over the floor of an area to suck dust or foreign substances from the floor; and a detection unit disposed on a front surface of the main body 10 to detect an obstacle.

The mobile robot 1 receives a charging stand return signal from a charging stand 40, and moves to a position of the charging stand 40 to return thereto. The mobile robot 1 may be docked to the charging stand 40 so that the mobile robot 1 may be connected to a charging terminal of the charging stand 40.

The mobile robot 1 returns to the charging stand 40 to receive power for moving and cleaning. Once the mobile robot 1 returns to the charging stand 40, a terminal 410 of the charging stand 40 and a terminal of the mobile robot 1 are electrically connected to each other, such that a charging current may be supplied to the main body 10. The charging stand 40 may also provide contactless charging for the mobile robot 1.

The mobile robot 1 and the charging stand 40 communicate with each other by wireless communication. The mobile robot 1 may communicate with the charging stand 40 by a method other than the charging stand return signal.

Further, the mobile robot 1 includes a holder 50 for storing a cleaning tool 60. A plurality of tools 60, which are auxiliary cleaning tools, may be received in the holder 50. Further, the holder 50 may have not only an inner space but also an outer space to receive the tools.

As illustrated in FIG. 1, the holder 50 has a cubic shape, but the shape may vary depending on a shape and a number of the tools 60 to be held therein.

Further, the holder 50 communicates with the charging stand 40. The holder 50 transmits a holding state of the held tools 60 to the charging stand 40. In the case where any one of the tools 60 is separated, the holder 50 may transmit a tool separation signal to the charging stand 40.

The tool 60 is inserted and fixed into an inner or outer space of the holder 50 to be held therein.

The tool 60 includes a communication module, to transmit a predetermined tool position signal including position information.

The tool 60 may use a GPS signal, an ultrasonic wave signal, an infrared signal, an electromagnetic signal, or an ultra wide band (UWB) signal, as a position signal.

As described above, examples of the tool may include a cleaning nozzle, auxiliary components of a suction unit, a brush, a wet cloth pad for wet cloth cleaning, a wet cloth, and the like.

In the case where the cleaning tool 60 is separated, the holder 50 generates and transmits a tool separation signal. The charging stand 40 receives the signal from the holder 50, which is located adjacent to the charging stand 40, and confirms that the tool 60 is separated. in the case where there are a plurality of tools, the holder 50 may generate different tool separation signals according to positions of the plurality of tools. Further, the holder 50 may simply distinguish between mounting and separation.

In the case where a communication unit is provided separately for each tool if necessary, the tool may transmit a signal for position confirmation at predetermined time intervals. Further, if necessary, the mobile robot 1 may communicate with the holder 50.

The holder 50 is positioned within a predetermined distance from the charging stand 40. The distance between the holder 50 and the charging stand 40 is determined according to a communication technique used therebetween.

The holder 50 may be fixed to the wall. Further, the holder 50 may include a separate stand (not shown), so to be located in an area without being fixed to the wall.

The mobile robot 1 includes: a casing (not shown) which forms an exterior of the main body 10 and a space to accommodate components of the main body 10; a suction nit 261 disposed at the casing to suck foreign substances such as dust, waste, and the like; and a left wheel (not shown) and a right wheel (not shown) which are rotatably provided at the casing. As the left wheel and the right wheel rotate, the main body 10 may move over the floor of an area to be cleaned, during which the suction unit 261 suctions foreign substances.

The suction unit 261 may include a suction fan (not shown) to generate a suction force; and a suction hole (not shown), through which air generated by rotation of the suction fan is suctioned. The suction unit 261 may also include: a filter to collect foreign substances from the air suctioned through the suction hole; and a foreign substance collecting container (not shown) where the foreign substances collected from the filter are stored. Further, the suction unit 261 includes a rotating brush (not shown), which rotates while suctioning the air to assist in collecting foreign substances. The suction unit may be detachable as needed. The main body 10 may be further provided with a plurality of brushes (not shown), which are positioned at a front bottom portion of the casing 11, and have radially extending bristles with a plurality of wings.

In addition, the main body 10 may include a traveling unit which drives the left wheel and the right wheel. The traveling unit may include at least one driving motor (not shown). The at least one driving motor may include a left wheel driving motor (not shown), which rotates the left wheel, and a right wheel driving motor (not shown) which rotates the right wheel.

The left wheel driving motor and the right wheel driving motor are controlled independently from each other by the travel control unit of the controller, such that the main body 10 may move forward, backward, or may turn. For example, in the case where the main body 10 moves forward, the left wheel driving motor and the right wheel driving motor may rotate in the same direction; however, when the left wheel driving motor and the right wheel driving motor may rotate at different speeds or rotate in opposite directions to each other, a traveling direction of the main body 10 may be changed. At least one auxiliary wheel (not shown) may be further provided to stably support the main body 10.

The detection unit includes an obstacle detection unit 100 for emitting patterned light, a sensor unit (not shown) including a plurality of sensors to sense an obstacle, an image acquirer (not shown) for capturing an image. The detection unit may sense an obstacle located in a traveling direction.

The obstacle detection unit 100 emits patterned light, and senses an obstacle using a captured image. The obstacle detection unit 100 is fixed to a front surface of the main body 10, and includes a pattern emission unit and a pattern acquirer, so that when the pattern acquirer captures an image of the emitted pattern, the obstacle detection unit 100 may sense an obstacle based on a change in a pattern shape.

The image acquirer is disposed to face forward to capture an image in a traveling direction, and may be disposed to face the ceiling in some cases. Further, the image acquirer may also be disposed to face forward at a surface tilted at a predetermined angle to capture a forward image and an image of the ceiling at the same time. In addition, a plurality of image acquirers may be provided to capture a forward image and an image of the ceiling separately. The main body 10 includes a battery (not shown) which supplies power for moving and sucking foreign substances.

The main body 10 may be equipped with a rechargeable battery 38, which is charged by connecting a charging terminal 33 to a commercial power source (for example, power outlet at home). Alternatively, the battery 38 is charged in such a manner that once main body 10 is docked to a separate charging stand 40 connected to the commercial power source, the charging terminal 33 comes into contact with a terminal 410 of the charging stand 40, to be electrically connected to the commercial power source. Electronic parts included in the mobile robot 1 may be supplied with power from the battery 38. Thus, upon charging the battery 38, the mobile robot 1 may travel autonomously after electrically separating from the commercial power source. Electronic components included in the mobile robot 1 may be supplied with power from the battery 38. Thus, when the battery 38 is fully charged, the mobile robot 1 may autonomously travel while being electrically separated from the commercial power source.

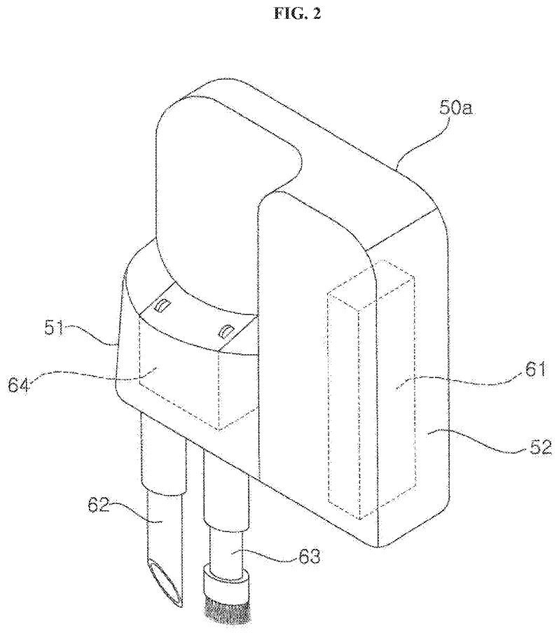

FIG. 2 is a diagram illustrating another example of the holder of FIG. 1.

As illustrated in FIG. 2, a holder 50a may charge and hold a hand vacuum cleaner. A holding part 51, in which the hand vacuum cleaner is held, has a charging terminal, and may include a battery housing 64 of the hand vacuum cleaner.

Further, cleaning tools 62 and 63 for the hand vacuum cleaner may be held at a bottom surface of the holder 50a. The holder 50a is connected to a power source to supply a charging current to the hand vacuum cleaner, held onto the holding part 51, or to the tools 62 and 63.

An accommodation part 52, which accommodates a cleaning tool 61 of the mobile robot 1 along with the holding part 51, may be provided. A shape of the holder 50a is not limited to FIG, 2, but the holding stand 50a may have various shape.

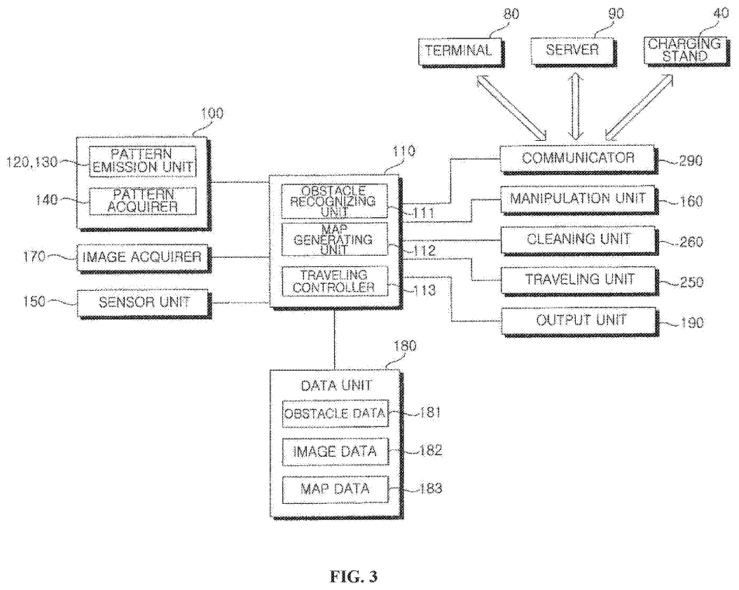

FIG. 3 is a block diagram illustrating principal components of a mobile robot according to an embodiment of the present disclosure. As illustrated in FIG. 3, the mobile robot 1 includes an obstacle detection unit 100, an image acquirer 170, a cleaning unit 260, a traveling unit 250, a data unit 180, an output unit 190, a manipulation unit, a communicator 280, and a controller 110 which controls the overall operation of the components.

The manipulation unit 180 has at least one button, a switch, a touch input means, and the like, to receive an input of an ON/OFF command or various commands, which are required for the overall operation of the mobile robot 100, and transmits the commands to the controller 110.

The output unit 190 includes a display such as an LED, an LCD, and displays an operation mode, reservation information, a battery state, an operating state, an error state, and the like of the mobile robot 1. Further, the output unit 190 includes a speaker or a buzzer to output a predetermined sound effect, a warning sound, or voice guidance, which corresponds to an operation mode, reservation information, a battery state, an operating state, an error state, and the like.

The communicator 280 may transmit and receive data by using a communication module including not only a near-field wireless communication such as Zigbee communication, Bluetooth communication, and the like, but also WIFI communication, WiBro communication, and the like.

The communicator 280 communicates with the terminal 80 by wireless communication.

The communicator 280 transmits a generated map to a terminal 80, receives a cleaning command from the terminal 80, and transmits data about an operating state and a cleaning state of the mobile robot 1 to the terminal 80. In addition, the communicator 280 receives, from the terminal 80, information on an obstacle located in a traveling area and operating information corresponding to the obstacle, and transmits the operating data of the mobile robot 1 to the terminal 80.

The communicator 280 is connected to the Internet through a home network to communicate with an external server 90. The communicator 280 transmits information on obstacles sensed by the obstacle detection unit 100 to the server 90 through the communicator 280, and receives data about obstacles from the server 90.

The communicator 280 communicates with the charging stand 40 to receive a charging stand return signal or a tool separation signal therefrom. Further, the communicator 280 may receive a tool position signal from a tool.

The traveling unit 250 includes at least one driving motor to enable the mobile robot 1 to travel according to a control command of the traveling controller 113. As described above, the traveling unit 250 may include a left wheel driving motor which rotates a left wheel and a right wheel driving motor which rotates a right wheel.

The cleaning unit 260 operates the brush to facilitate suctioning of dust or foreign substances near the robot cleaner 1, and operates the suction unit to suck dust or foreign substances. The cleaning unit 260 controls the suction fan included in the suction unit 261 that suctions foreign substances such as dust or waste, so that dust may be drawn into the foreign material collecting container (dust container) through the suction hole.

Further, the cleaning unit 260 is mounted at a rear bottom surface of the main body 10 to include a wet cloth cleaning unit (not shown), which comes into contact with a floor surface to perform wet mopping of the floor surface, and a water container (not shown) which supplies water to the wet mopping part. The cleaning unit 260 may include a cleaning tool. For example, a wet cloth pad may be provided for the wet mopping part to clean the floor surface.

The battery (not shown) may supply power to the driving motor, as well as power required for the overall operation of the mobile robot 1. When the battery is discharged, the mobile robot 1 may travel to return to the charging stand 40 for charging. While returning, the mobile robot 1 may autonomously detect the position of the charging stand 40. The charging stand 40 may include a signal transmitter (not shown) which transmits a predetermined return signal. The return signal may be an ultrasonic wave signal or an infrared signal, but is not limited thereto.

The data unit 180 stores sensing signals input from the obstacle detection unit 100 or the sensor unit 150, reference data for determining obstacles, and obstacle information on sensed obstacles.

The data unit 180 stores obstacle data 181 for determining types of obstacles, image data 182 of captured images, and map data 183 about areas. The map data 183 includes obstacle information, and various types of maps about traveling areas detected by the mobile robot 1. For example, the map data stores a base map including information about traveling areas detected by the mobile robot 1, a cleaning map generated by dividing areas of the base map, a user map showing shapes of the areas of the cleaning map so that a user may identify the shapes, and a guide map generated by overlapping the cleaning map and the user map.

The obstacle data 181 is data for recognizing obstacles and determining types of the obstacles. The obstacle data 181 includes: motion information about operations of the mobile robot 1 in response to a sensed obstacle, e.g., a traveling speed, a traveling direction, information on whether to avoid the obstacle, or whether to stop traveling, and the like; and data about a sound effect, a warning sound, voice guidance which are output through a speaker 173. The image data 182 includes captured images and recognition information for recognizing obstacles received from a server.

Further, the data unit 180 stores control data for controlling the operation of the mobile robot 1, data according to a cleaning mode of the mobile robot 1, and sensing signals of the sensor unit 150 such ultrasonic waves, laser, and the like.

The data unit 180 may store data readable by a microprocessor, and may include Hard Disk Drive (HDD), Solid State Disk (SSD), Silicon Disk Drive (SDD), ROM, RAM, CD-ROM, a magnetic tape, a floppy disc, and an optical data storage device.

The obstacle detection unit 100 includes a first pattern emission unit 120, a second pattern emission unit 130, and a pattern acquirer 140.

The image acquirer 170 is at least one in number.

The image acquirer 170 is installed to face forward to capture a forward image in a traveling direction, and may also capture an image of a front ceiling. In some cases, the image acquirer 170 may be provided separately for capturing a forward image and an image of the ceiling.

Further, the detection unit may include a sensor unit 150 including at least one sensor. In some case, the obstacle detection unit 100 may include the sensor unit.

As described above, the obstacle detection unit 100 is installed at a front surface of the main body 10 to emit first patterned light and second patterned light forward from the mobile robot 1. and acquires an image of the patterned light. The obstacle detection unit 100 inputs the acquired image to the controller 110 as an obstacle sensing signal.

The first pattern emission unit 120 and the second pattern emission unit 130 of the obstacle detection unit 100 each include a light source, and an Optical Pattern Projection Element (OPPE) which generates a predetermined pattern by transmission of light emitted from the light source. The light source may be a laser diode (LD), a light emitting diode (LED), and the like. Laser light has excellent monochromaticity, straightness, and connectivity properties, as compared to other light sources, thereby enabling fine distance measurement. Particularly, since infrared light or visible light has a high deviation in precision of distance measurement according to factors, such as colors and materials of a target object, it is desired to use the laser diode as the light source. The OPPE may include a lens or a diffractive optical element (DOE). Depending on the configuration of the OPPE included in each of the first pattern emission unit 120 and the second pattern emission unit 130, light in various patterns may be emitted.

The pattern acquirer 140 may acquire a forward image of the main body 10. Particularly, patterned light is displayed on the image acquired by the pattern r 140 (hereinafter referred to as an acquired image), in which images of the patterned light displayed on the acquired image will be hereinafter referred to as optical patterns, which are images of the patterned light incident on an actual space and projected on the image sensor.

In the case where no pattern emission unit is included, the pattern acquirer 140 acquires a forward image of the main body 10, in which no patterned light is included.

The pattern acquirer 140 may include a camera, which converts an image of a subject into an electric signal, converts the electric signal into a digital signal, and then stores the digital signal in a memory device. The digital camera includes an image sensor (e.g., CMOS image sensor), including a plurality of photodiodes pixel), and a digital signal processor (DSP) which generates images using signals output from the photodiodes. The DSP may generate not only still images but also moving images having frames of still images.

The image sensor is a device that converts an optical image into an electrical signal, and is formed as a chip having a plurality of photodiodes integrated therein. For example, the photodiodes may be pixels. When light, having passed through the lens, forms an image on the chip, charges are accumulated in the respective pixels constructing the image, and the charges accumulated in the pixels are converted into an electrical signal (for example, voltage). As is well known, a Charge Coupled Device (CCD), a Complementary Metal Oxide Semiconductor (CMOS), and the like, may be used as the image sensor.

The image processor generates a digital image using an analog signal output from the image sensor. The image processor includes: an A/D converter to convert the analog signal into a digital signal; a buffer memory to temporarily store digital data according to the digital signal output from the A/D converter; and a digital signal processor (DSP) to generate a digital image by processing the data stored in the buffer memory.

The obstacle detection unit 100 analyzes patterns of the acquired images, and senses obstacles based on shapes of the analyzed patterns. The sensor unit 150 uses sensors to sense obstacles which are located within a sensing distance of each sensor.

The sensor unit 150 includes a plurality of sensors to sense obstacles. The sensor unit 150 uses at least one of laser, ultrasonic waves, and infrared, to sense obstacles located in front of the main body 10, i.e., in a traveling direction. Further, the sensor unit 150 may also include a cliff sensor to sense whether there is a cliff on a floor of a traveling area. When a transmitted signal is incident by reflection, the sensor unit 150 inputs information on the existence of an obstacle or a distance to an obstacle into the controller 100 as an obstacle sensing signal.

Once the mobile robot 1 operates, the image acquirer 170 captures successive images. Further, the image acquirer 170 may capture images at predetermined intervals. Even in a traveling or cleaning mode, in which the obstacle detection unit 100 senses no obstacle, the image acquirer 170 captures images.

For example, once the image acquirer 170 captures an image once, and then moves in the same traveling direction, while the traveling direction is maintained without being changed, images captured by the image acquirer 170 are images of the same obstacle captured once, with the only difference being in the size thereof, such that the image acquirer 170 captures images periodically. The image acquirer 170 may capture images at predetermined time intervals or distance intervals. In the case where a traveling direction is changed, the image acquirer 170 captures new images.

The image acquirer 170 may set an image capturing period according to a moving speed of the mobile robot 1. Further, the image acquirer 170 may set an image capturing period by considering a sensing distance of the sensor unit and a moving speed of the mobile robot 1.

The image acquirer 170 may store images, captured while the main body 10 travels, as image data 182 in the data unit 180.

While traveling, the obstacle detection unit 100 senses an obstacle located in a traveling direction, and inputs a sensing signal to the controller 110. The obstacle detection unit 100 inputs information on a position or movement of the sensed obstacle to the controller 110. The pattern acquirer 140 inputs an image, including the pattern emitted by the pattern emission unit, into the controller 110 as a sensing signal, and the sensor unit 150 inputs a sensing signal of the obstacle, sensed by the sensor, to the controller 110.

The controller 110 controls the traveling unit 250 so that the mobile robot 1 travels within a designated area of a traveling area.

The controller 110 sets an operation mode of the mobile robot 1 by processing data input by manipulation of the manipulation unit 160, and outputs an operating state of the mobile robot 1 through the output unit 190, The controller 110 controls to output, through a speaker, an operating state, an error state, or a warning sound, a sound effect, and voice guidance in response to a sensed obstacle.

The controller 110 controls the traveling unit 250 and the cleaning unit 260 while traveling to perform cleaning of a traveling area by sucking dust or foreign substances around the mobile robot 1. Accordingly, the cleaning unit 260 operates the brush to facilitate suctioning of dust or foreign substances around the robot cleaner 1, and operates the suction unit to suck dust or foreign substances. The controller 110 controls the cleaning unit 260 to perform cleaning by sucking foreign substances while traveling.

The controller 110 checks a battery capacity and determines a time to return to the charging stand. Once a battery capacity reaches a predetermined value, the controller 110 stops an operation which is currently performed, and starts to detect a charging stand to return thereto. The controller 110 may output notification about a battery capacity and notification for returning to the charging stand.

In response to an obstacle sensed by the image acquirer 170 or the obstacle detection unit 100, the controller 110 recognizes the obstacle and sets any one of a plurality of motions corresponding to the obstacle. In the case where the sensing signal is an image included in a pattern, the controller 110 may determine the sensing signal differently according to pattern shapes, and may distinguish obstacles according to sensing signals, i.e., pattern shapes.

Further, upon receiving a charging stand return signal, which is transmitted from the charging stand, through the communicator, or upon receiving a tool separation signal, the controller 110 may return to the charging stand. When receiving the tool separation signal, the controller 110 may detect a user having a tool; and upon receiving a tool position signal, which is transmitted from the tool, through the communicator, the controller 110 controls the traveling unit to move to the position.

By controlling traveling in response to the tool separation signal, the controller 110 may move or rotate by identifying tool mounting positions while approaching the user of the tool.

The controller 110 may identify the type of a tool based on the received tool separation signal. By identifying the type of a tool, the controller 110 may control the traveling unit to rotate or move according to a tool mounting position. In the case where the controller 110 may not identify the type of a tool based on the received tool separation signal, the controller 110 may control the traveling unit to detect a tool and to approach the position of the tool.

The controller 110 includes an obstacle recognizing unit 111, a map generating unit 112, and a traveling controller 113.

At an initial stage of operation, or in the case where a map of a cleaning area is not stored, the map generating unit 112 generates a map of a cleaning area while traveling based on obstacle information. Further, the map generating unit 112 may update a previously generated map based on obstacle information obtained while traveling.

The map generating unit 112 generates a base map based on information obtained from the obstacle recognizing unit 111 while traveling, and generates a cleaning map by dividing areas of the base map. Further, the map generating unit 112 generates a user map and a guide map by simplifying the areas of the cleaning map, and setting characteristic of each area. The base map is a map displaying an outline of the cleaning area obtained while traveling, and the cleaning map is a map generated by dividing areas of the base map. The base map and the cleaning map include traveling areas of the mobile robot 1 and obstacle information. The user map is a map processed by simplifying the areas of the cleaning map and organizing the outline of the cleaning map, with a visual effect added thereto. The guide map is a map generated by overlapping the cleaning map and the user map. As the guide map shows the cleaning map, a cleaning command may be input based on areas where the mobile robot 1 may actually travel.

Upon gene the base map, the map generating unit 112 generates a map by dividing the cleaning area into a plurality of areas, and by including a connecting passage for connecting the plurality of areas, and information on obstacles of each of the areas. The map generating unit 112 may generate a map, in which areas are divided by separating small areas, setting a representative area, setting the separated small areas as sub-areas, and incorporating the areas into the representative area.

The map generating unit 112 processes a shape of each of the divided areas. The map generating unit 112 sets characteristics of each of the divided areas, and processes the shape of each of the divided areas according to characteristics of the areas.

The obstacle recognizing unit 111 determines an obstacle based on data input from the image acquirer 170 or the obstacle detection unit 100. The map generating unit 112 generates a map of a traveling area, and includes information on the sensed obstacle in the map. Further, in response to the obstacle information, the traveling controller 113 changes a moving direction or a traveling path of the mobile robot 1, so as to control the traveling unit 250 to travel by passing through or avoiding the obstacle.

The obstacle recognizing unit 111 determines an obstacle by analyzing data input from the obstacle detection unit 100. The obstacle recognizing unit 111 calculates a direction of an obstacle or a distance to an obstacle based on ultrasonic waves, laser, and the like, and determines an obstacle by extracting a pattern by analyzing the acquired image including a pattern, and analyzing a shape of the pattern. When using an ultrasonic wave signal or an infrared signal, the shape and time of the received ultrasonic waves are different according to the distance and position of obstacles, such that the obstacle recognizing unit 111 determines an obstacle based on the shape and time of the received ultrasonic waves.

The obstacle recognizing unit 111 may sense a human body. The obstacle recognizing unit 111 senses a human body by analyzing data input from the obstacle detection unit 100 or the image acquirer 170, and determines whether the human body is a specific user.

The obstacle recognizing unit 111 stores data of previously registered users, e.g., images of users and features according to shapes of users, and determines whether a user is a registered user when sensing a human body.

Further, once image data of obstacles captured by the image acquirer 170 are input, the obstacle recognizing unit 111 stores the image data in the data unit 180. The image acquirer 170 captures images of an obstacle, located in front of the mobile robot 1, several times, such that a plurality of image data are stored in the data unit 180. In addition, when the image acquirer 170 successively captures images in a traveling direction, the obstacle recognizing unit 111 stores the input moving image as image data, or stores the moving image as image data by dividing the image in units of frames.

The obstacle recognizing unit 111 analyzes a plurality of image data, and determines whether a captured subject, i.e., an obstacle, is recognizable. In this case, the obstacle recognizing unit 111 analyzes the image data, and determines whether the image data are recognizable. For example, the obstacle recognizing unit 111 separates a shaken image, an image too dark to identify an obstacle, and an unfocused image, and discards the images. The obstacle recognizing unit 111 analyzes the image data, and extracts features of the obstacles from the image data, The obstacle recognizing unit 111 determines obstacles based on the shape, size, and color of obstacles, and determines positions of the obstacles. The obstacle recognizing unit 111 analyzes obstacles based on a plurality of previously captured images, and determines obstacles by analyzing images captured before a time point when an obstacle is determined to be located at a designated distance.

The obstacle recognizing unit 111 removes a background from image data, and determines types of obstacles by extracting features based on previously stored obstacle data. The obstacle data 181 are updated by receiving new obstacle data from a server. The mobile robot 1 stores obstacle data on sensed obstacles, and may receive other data, e.g., data on the types of obstacles, from the server.

The obstacle recognizing unit 111 detects features such as points, lines, surfaces, and the like, of predetermined pixels constituting an image, and detects obstacles based on the detected features.

The obstacle recognizing unit 111 extracts an outline of an obstacle, and recognizes the obstacle based on the outline, to determine the type of the obstacle. The obstacle recognizing unit 111 may determine the type of the obstacle based on the shape, color, and size of the obstacle. Further, the obstacle recognizing unit 11 may determine the type of the obstacle based on the shape and movement of the obstacle.

The obstacle recognizing unit 111 distinguishes humans, animals, and objects based on the obstacle information. The obstacle recognizing unit 111 classifies the types of obstacles into categories of an ordinary obstacle, a dangerous obstacle, a living body obstacle, and a floor obstacle, and may determine the types of obstacles in detail for each category.

Further, the obstacle recognizing unit 111 transmits recognizable image data to the server 90 through the communicator 280 to determine the types of obstacles. The communicator 280 transmits at least one image datum to the server 90.

Upon receiving the image data from the mobile robot 1, the server 90 analyzes the received image data, and extracts an outline or a shape of the captured subject. By comparing the extracted outline or shape with previously stored obstacle data, the server 90 determines the types of obstacles. The server 90 determines the types of obstacles by first searching for obstacles having a similar shape or color, extracting features from corresponding image data, and comparing the features.

Upon determining the type of the obstacle, the server 90 transmits data on the obstacle to the mobile robot 1.

The obstacle recognizing unit 111 stores data on obstacles, received from the server 90 through the communicator 280, in the data unit 180 as obstacle data. Once the server 90 determines the type of the obstacle, the obstacle recognizing unit 111 operates an operation corresponding to the type of the obstacle. The traveling controller 113 controls the traveling unit to avoid, approach, or pass through the obstacle according to the type of the obstacle, and outputs a predetermined sound effect, a warning sound, and voice guidance through a speaker in some cases.

As described above, the obstacle recognizing unit 111 determines whether the image data are recognizable, and transmits image data according to the stored obstacle data to the server 90, to determine the types of obstacles based on a response of the server 90.

Further, the obstacle recognizing unit 111 stores obstacle data on an obstacle, selected from among a plurality of obstacles, for recognizing the obstacle, such that even without transmitting image data to the server 90, the obstacle recognizing unit 111 may recognize an obstacle based on the obstacle recognition data.

The traveling controller 113 controls the traveling unit 250 to independently operate the left wheel driving motor and the right wheel driving motor, such that the main body 10 may move straight or rotate. The traveling controller 113 controls the traveling unit 250 and the cleaning unit 260 according to a cleaning command, so that the main body 10 performs cleaning by sucking foreign substances while traveling in an area to be cleaned.

Upon recognizing the type of the obstacle based on the image data, the traveling controller113 controls the traveling unit 250, so that the main body 10 performs a predetermined operation corresponding to the type of the obstacle.

Upon determining that an obstacle is located within a predetermined distance based on a sensing signal of the obstacle detection unit 100, the traveling controller 113 sets and performs, according to the type and shape of the determined obstacle, any one of a plurality of corresponding motions, which may be performed according to the type and shape of sensing signals.

In the case where the obstacle detection unit 100 senses that an obstacle is located within a predetermined distance, the traveling controller 113 sets a plurality of corresponding motions, such as avoiding, approaching, setting an approaching distance, stopping, decreasing or increasing speed, moving backward, making a U-turn, changing a traveling direction, and the like, according to a sensing signal, and controls the traveling unit by setting any one of the corresponding motions according to an obstacle determined based on previously capture image data.

The traveling controller 113 may output an error, and may output a predetermined warning sound or voice guidance as needed.

Further, upon receiving a tool separation signal from the communicator 280, the traveling controller113 controls the traveling unit 250 to move to mount a tool according to a position of the main body 10.

Once the tool is separated from the holder 50, the holder 50 transmits a tool separation signal to the charging stand 40, and the charging stand 40 transmits the tool separation signal to the mobile robot 1.

When the traveling controller 113 receives the tool separation signal while the mobile terminal 10 is docked to the charging stand 40, the traveling controller 113 controls the traveling unit 250 to become separated from the charging stand 40 and to move a predetermined distance.

In addition, once the obstacle recognizing unit 111 senses that a user is positioned within a predetermined distance, the traveling controller 113 controls the traveling unit 250 to approach the user.

If necessary, the traveling controller 113 controls the traveling unit 250 to rotate by a predetermined angle in response to the separated tool. Accordingly, the traveling unit 250 becomes separated from the charging stand 40 and moves. Further, if it is required to rotate, the traveling unit 250 moves so that the main body 10 may rotate by a predetermined angle.

For example, in the case where the separated cleaning tool is a wet cloth pad, the traveling unit 250 is a cleaning tool mounted at a rear surface of the main body 10, such that the traveling unit 250 may rotate the main body 10, so that a rear surface of the main body 10 may face the user.

In the case where the tool is not mounted after waiting for a predetermined period of time, the traveling controller 113 returns to a preset operation. That is, when the mobile robot 1 receives the tool separation signal while being docked to the charging stand 40, and becomes separated from the charging stand 40, the traveling controller 113 controls the main body 10 to be docked again to the charging stand 40.

Further, upon receiving the tool separation signal while traveling, the traveling controller 113 controls the traveling unit 20 to move to the charging stand 40 or to the holder 50. According t:o a control command of the traveling controller 113 and based on a previously stored map, the traveling unit 250 may move to a position of the charging stand 40, which is stored in the map. In addition, the traveling unit 250 may move to the charging stand 40 based on a charging stand return signal, which is transmitted from the charging stand 40.

While traveling, when the traveling controller 113 receives the tool separation signal, and a tool position signal which is transmitted from the tool, the traveling controller 113 tracks the tool position signal to move to a position of the tool. The traveling unit 250 moves to the position of the tool according to a control signal of the traveling controller 113, and approaches the tool.

While the main body 10 moves to the charging stand 40 or to the position of the tool, the obstacle recognizing unit 111 senses a user (human body). In this case, the obstacle recognizing unit 111 analyzes data, input from the obstacle detection unit 100 or the image acquirer 170, and stores a registered human body, i.e., information on a specific user, such that the obstacle recognizing unit 111 may identify a specific user among a plurality of users.

Upon sensing a human body while the main body 10 moves to the charging stand 40 or to the position of the tool, the traveling controller 113 controls the traveling unit 250 to move to the human body. As the tool may be separated from the holder by a user, the controller 110 may determine that the human body, sensed while moving to the charging stand 40 or to the position of the tool, is a user having the tool. Further, by distinguishing a specific user from other users, the traveling controller 113 may determine that the specific user has a tool even when other human body is sensed.

Upon moving to the sensed human body by a predetermined distance, the main body 10 waits for mounting the tool for a predetermined period of time.

In the case where the sensed human body has the tool, the user mounts the tool while the main body 10 waits. By contrast, if the sensed human body does not have the tool, the user moves past the main body 10.

Then, after waiting for a predetermined period of time, the traveling controller 113 determines whether the tool is mounted. Further, the traveling controller 113 determines whether to re-detect the tool.

In the case where the tool is not mounted, the traveling controller 113 controls the traveling unit 250 to move again to the charging stand 40, which is a previous destination. further, upon receiving a position signal of the tool, the traveling controller 113 controls the traveling unit 250 to move again based on the received position signal of the tool.

Once the obstacle recognizing unit 111 senses a human body while traveling, the traveling controller 113 may repeat the process of approaching the human body by a predetermined distance and waiting for a predetermined period of time, as described above.

Further, upon receiving a tool position signal, when the tool position signal is apart from a position of the human body by more than a predetermined distance, the traveling controller 113 may ignore the human body sensed while traveling, and may continue traveling.

Upon arriving at the charging stand 40 or the position of the tool 60, the traveling controller 113 approaches the charging stand or the position of the tool by a predetermined distance. Upon arriving at the charging stand 40 or the position of the tool 60, the obstacle detection unit 100 or the image acquirer 170 captures an image of a surrounding area to sense an obstacle, and the obstacle recognizing unit 111 may sense a human body or the tool 60 based on input data.

In the case where a human body is located near the position of the tool 60, the traveling controller 113 approaches the human body by a predetermined distance and waits. The traveling unit 250 may rotate by a predetermined angle if necessary.

Once the tool 60 is mounted while waiting, the traveling controller 113 controls the traveling unit 250 and the cleaning unit 260 to perform a predetermined operation according to a setting input from the manipulation unit.

In the case where the tool is not mounted even after the traveling controller 113 arrives at the charging stand 40 or the position of the tool 60 and waits for a predetermined period of time, the traveling controller 113 checks a residual quantity of the battery, and determines whether to charge the battery or to continue traveling. If the battery requires charging, the traveling controller 113 may be docked to the charging stand 40 to charge the battery.

Further, in the case where the tool does not include a separate communication module, upon receiving a tool separation signal from the charging stand 40, the traveling controller 113 moves to the center of areas, sequentially starting from an adjacent area, and detects a human body or a tool while rotating. In the case where a human body or a tool is not sensed in a first area, the traveling controller 113 moves to a subsequent second area and to the center of the second area, and detects a human body or a tool while rotating at the center of the area.

In the case where a human body is sensed, the traveling controller 113 approaches the sensed human body by a predetermined distance, and waits. In the case where the tool is not mounted, the traveling controller 113 controls the traveling unit 250 to move to a next area.

In the case where the tool 60 is mounted while waiting, the traveling controller 113 controls the traveling unit 250 and the cleaning unit 260 to perform a predetermined operation according to a setting input by the manipulation unit.

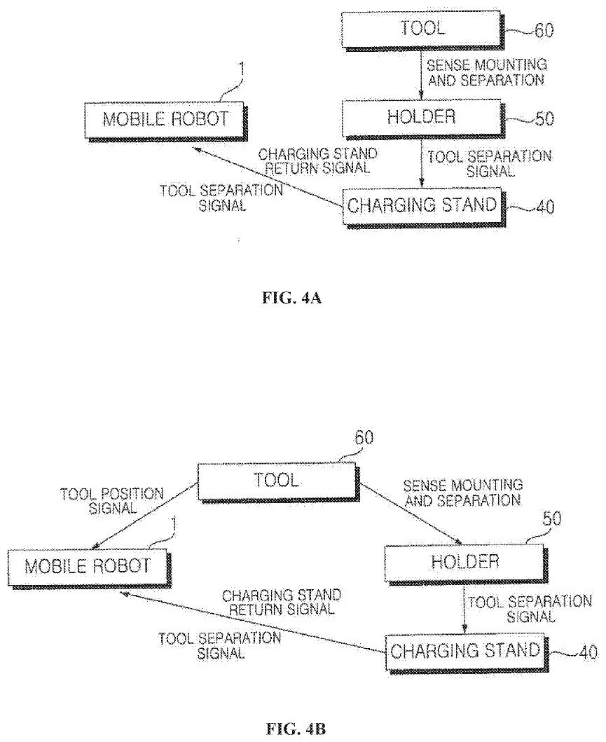

FIGS. 4A and 4B are diagrams illustrating a signal flow between a mobile robot, a holder, and a charging stand according to an embodiment of the present disclosure. As illustrated in FIG. 4A, the mobile robot 1, the holder 50, and the charging stand 40 transmit and receive data.

The holder 50 transmits a signal to the charging stand 40, and the charging stand 40 transmits the received signal to the mobile robot 1. In some cases, the holder 50 may transmit a signal to the mobile robot 1. The mobile robot 1 receives a return signal from the charging stand 40, and in the case where the mobile robot 1 is located at a position which falls outside a return signal coverage range, the mobile robot 1 may be connected to the charging stand 40 through a network formed in an indoor area, e.g., through WIFI communication.

Once the tool 60 is mounted, the holder 50 may transmit a mounting signal.

Once the tool 60 held in the holder 50 is separated from the holder 50, the holder 50 senses separation of the tool 60, and transmits a tool separation signal to the charging stand 40. Upon receiving the tool separation signal, the charging stand 40 transmits the received tool separation signal to the mobile robot 1. The tool separation signal may be replaced with a charging stand return signal.

While the mobile robot 1 is docked to the charging stand 40, the mobile robot 1 is separated form the charging stand 40 to move; and while the mobile robot 1 travels, the mobile robot 1 may move to the charging stand 40 based on a pre-stored map. Further, the mobile robot 1 may directly move to the charging stand 40 based on the charging stand return signal.

The mobile robot 1 moves so that the tool, separated from the holder 50, may be mounted in the mobile robot 1. Further, the mobile robot 1 moves to facilitate mounting of the tool.

If necessary, the mobile robot 1 travels in an area based on a map, to detect a tool or a user having the tool. Upon sensing separation of the tool, the mobile robot 1 moves to facilitate mounting of the tool.

As illustrated in FIG. 4B, the tool may transmit a predetermined position signal. For example, the tool 60 may transmit a UWB signal as a position signal. The mobile robot 1 may determine a position of the tool by receiving the UW13 signal from the tool.

Once the tool 60, which transmits a position signal, is separated from the holder 50, the holder 50 transmits the tool separation signal to the charging stand 40, which then transmits the tool separation signal to the mobile robot 1, as described above. Accordingly, the mobile robot 1 moves to the charging stand 40; and upon sensing the tool position signal while moving, the mobile robot 1 tracks the tool position signal to move to the position of the tool.

Upon approaching the tool, or a nearby position where a human body is sensed, the mobile robot 1 waits for a predetermined period of time, and determines whether the tool is mounted.

For example, in the case where the separated tool is mounted, the mobile robot 1 performs a predetermined operation. In the case where the mounted tool is a wet cloth pad, the mobile robot 1 perform wet cloth cleaning in a predetermined area.

By distinguishing a specific user from a plurality of users, the mobile robot 1 may determine that the specific user has the tool even when other human body is sensed.

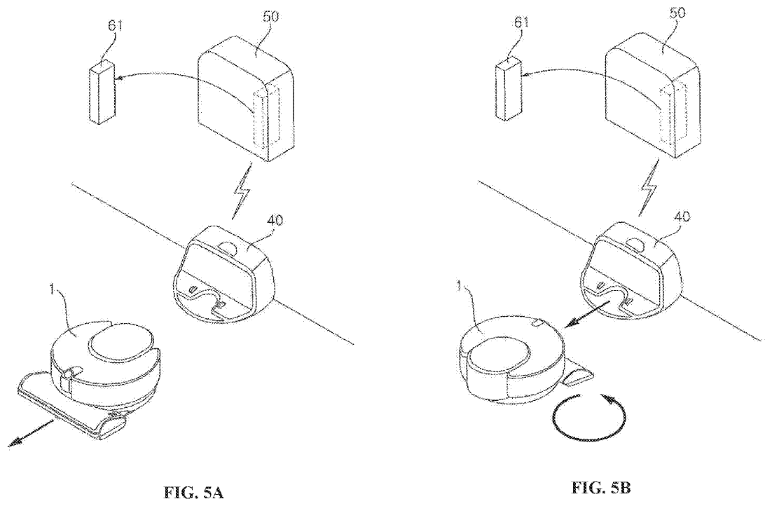

FIGS. 5A and 5B are diagrams illustrating an operation of a mobile robot in response to sensing separation of a tool according to an embodiment of the present disclosure. As illustrated in FIG. 5A, while the mobile robot 1 is docked to the charging stand 40, when a first tool 61 is separated form the holder 50 held in the holder 50, the mobile robot 1 becomes separated from the holder 50 according to a tool separation signal, which is transmitted from the holder 50 to the charging stand 40, and then is transmitted from the charging stand 40 to the mobile robot 1, and the mobile robot 1 moves a predetermined distance.

While the mobile robot 1 is docked to the charging stand 40, it is difficult to mount the tool, such that the mobile robot 1 moves a predetermined distance to be separated from the holder 50.

As illustrated in FIG. 5B, after the mobile robot 1 moves a predetermined distance away from the charging stand 40, the mobile robot 1 determines whether to rotate according to a tool mounting position, and moves forward and rotates by a predetermined angle at that position.

For example, in the case where the tool is mounted at a rear side of the mobile robot 1, the mobile robot 1 may rotate while remaining in place, to facilitate mounting of the tool.

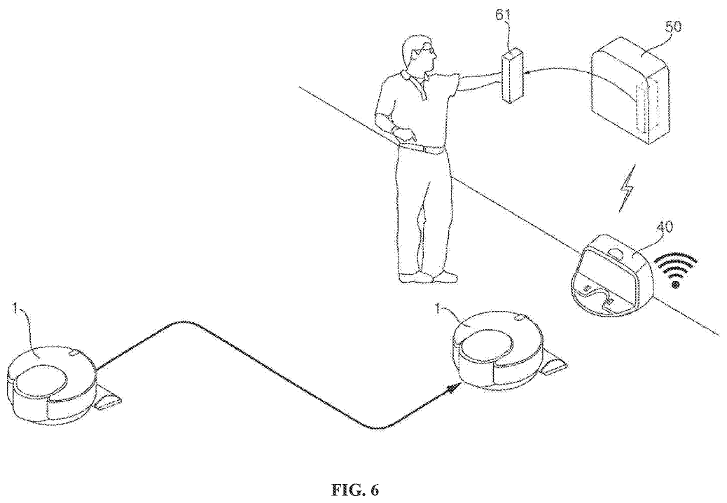

FIG. 6 is a diagram illustrating a traveling operation of a mobile robot in response to sensing separation of a tool according to an embodiment of the present disclosure. As illustrated in FIG. 6, while the mobile robot 1 travels in an area, when the first tool 61 is separated from the holder 50, the mobile robot 1 receives a tool separation signal from the charging stand 40, and moves to the charging stand 40.

The mobile robot 1 approaches the charging stand 40 by a predetermined distance, and waits for a predetermined period of time for a user to mount the tool

While traveling to the charging stand 40 according to the tool separation signal, once the obstacle recognizing unit 111 senses a human body, the mobile robot 1 may approach the sensed human body by a predetermined distance. As the tool is separated by a user, the obstacle recognizing unit 111 may recognize that the sensed human body is a user having the tool, and approaches the human body by a predetermined distance and waits. By distinguishing a specific user from a plurality of users, the mobile robot 1 may determine that the specific user has the tool even when other human body is sensed.

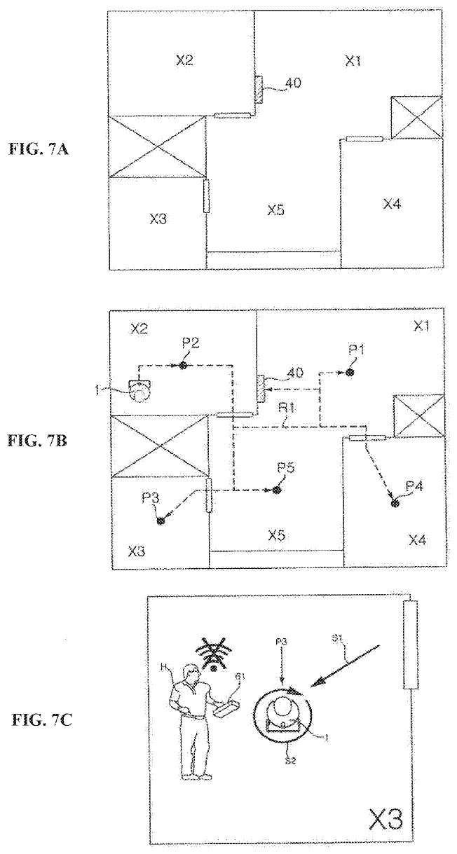

FIGS. 7A-7C are diagrams referred to in explaining a tool detecting method of a mobile robot in response to sensing separation of a tool according to an embodiment of the present disclosure.

As illustrated in FIG. 7A, an indoor area is composed of a plurality of areas X1 to X5. While traveling in the indoor area, the mobile robot 1 generates and stores a map of the area.

The following description is made by using an example where the charging stand 40 is located in a first area X1. The holder 50 is also installed at a position which is adjacent to or the same as the charging stand 40.

While traveling, the mobile robot 1 receives a tool separation signal from the charging stand 40.

The mobile robot 1 moves to the charging stand 40, and may sense a human body or a tool while moving. Upon moving to the charging stand 40, when the mobile robot 1 does not sense a human body or a tool, the mobile robot 1 may move to each area to detect a human body or a tool.

Further, as illustrated in FIG, 7B, the mobile robot 1, which is located in a second area. X2, does not directly move to the charging stand 40, but moves along a first route R1 starting from an adjacent area, to detect a tool.

Upon completing detection of the second area X2, the mobile robot 1 may move to a fifth area X5 or to the first area X1, or may also detect a third area X3 or a fourth area X4.

In addition, as illustrated in FIG. 7C, the mobile robot 1 moves to the center point (P1 to P5) of each area and rotates in the area, to detect whether a human body or a tool exists in the area.

For example, the mobile robot 1 may move to a third point P3, which is a center point of the third area X3, and may rotate to detect a human body or a tool located in the third area.

The mobile robot 1 may stop after rotating by a predetermined angle, or may continue rotating at the center point.

Upon sensing a human body in the third area X3, the mobile robot 1 moves to the human body by a predetermined distance, and waits for the tool to be mounted. The tool does not have a communication function or a signal transmission function, such that the mobile robot 1 may detect the tool by sensing a human body.

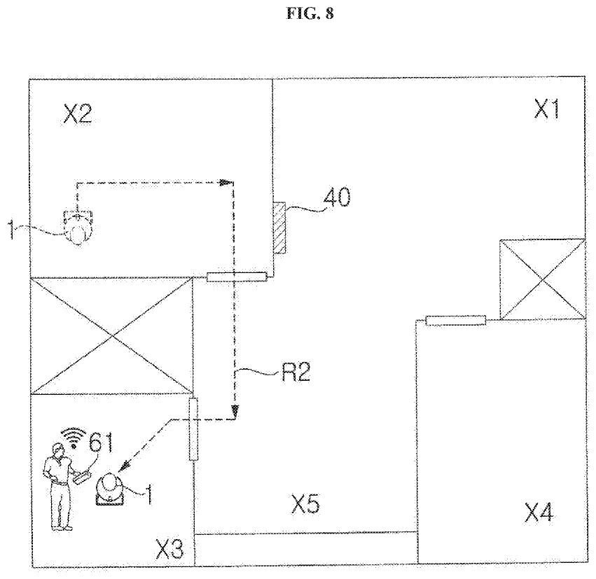

FIG. 8 is a diagram referred to in explaining a tool approaching method of a mobile robot based on a tool position signal according to an embodiment of the present disclosure.

As illustrated in FIG. 8, the cleaning tool 60 may have a signal transmission function. When the first tool 61 is separated from the holder 50, the first tool 1 transmits a tool position

Accordingly, the mobile robot 1 may move to the charging stand 40 by receiving the tool separation signal from the charging stand 40; or when receiving the tool separation signal while moving, the mobile robot 1 may move by tracking the tool position signal, instead of the charging stand 40, along a second route R2.

In the case where the tool is located within a short distance, the mobile robot 1 receives the tool position signal from the tool, and may directly move to the position of the tool.

Accordingly, the mobile robot 1 may move from the second area X2 to the third area X2.

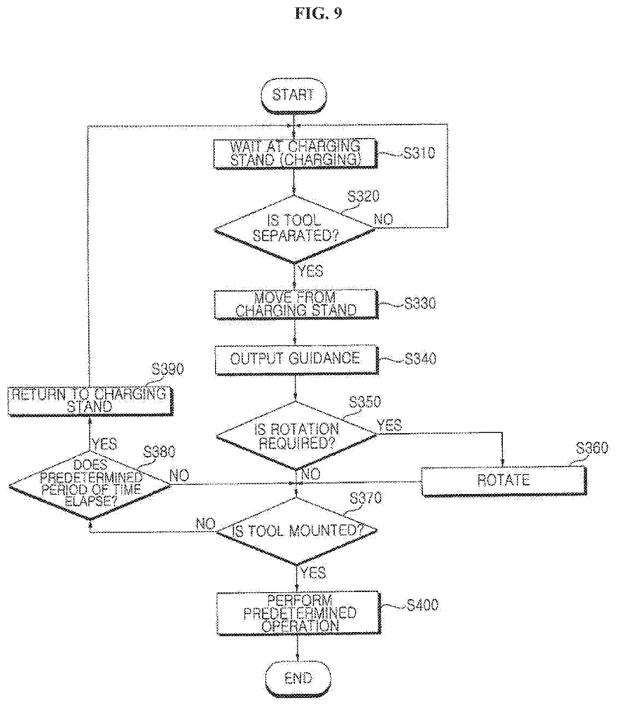

FIG. 9 is a flowchart illustrating a controlling method of a mobile robot in response to sensing separation of a tool during battery charging, according to an embodiment of the present disclosure.

As illustrated in FIG. 9, while the mobile robot 1 is docked to the charging stand 40 to charge the battery, the mobile robot 1 may wait for a cleaning command in S310,

Once the tool 60 is separated from the holder 50 during battery charging, the holder 50 transmits a tool separation signal to the charging stand 40, which in turn transmits the tool separation signal to the mobile robot 1 in S320. The communicator receives the tool separation signal, and sends the tool separation signal to the controller.

The traveling controller 113 controls the traveling unit, so that the main body 10 becomes separated from the charging stand 40 to move a predetermined distance in S330.

The traveling controller 113 outputs guidance on separation and mounting of the tool in S340. The guidance may be voice guidance, and a designated sound effect may be output in some case.

The mobile robot 1 determines whether it is required to rotate based on a mounting position of the tool in S350, and if it is required, the mobile robot 1 rotates by a predetermined angle in S360.

The mobile robot 1 waits for a predetermined period of time.

While waiting, the mobile robot 1 senses whether the tool is mounted in S370, and once the tool is mounted, the mobile robot 1 performs a predetermined operation in S400. If necessary, the mobile robot 1 may perform a designated operation depending on tools.

In the case where the tool is not mounted while waiting, after a predetermined period of time elapses in S380, the mobile robot 1 may return to the charging stand 40 to charge the battery again. In some cases, the mobile robot 1 may detect the tool based on a map.

Further, upon receiving a tool mounting signal from the holder 50 while waiting, the mobile robot 1 may return to the charging stand 40 to charge the battery again.

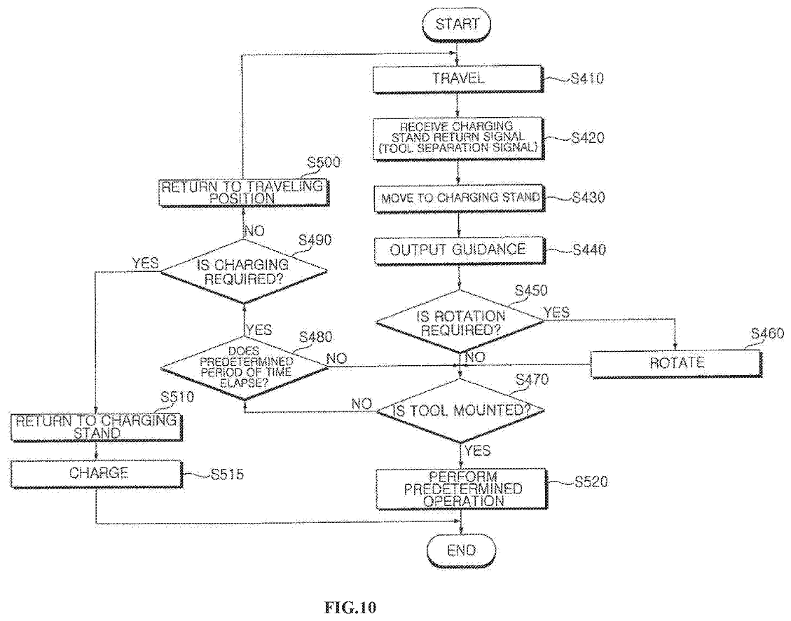

FIG. 10 is a flowchart illustrating a controlling method of a mobile robot in response to sensing separation of a tool while the mobile robot travels, according to an embodiment of the present disclosure.

As illustrated in FIG. 10, while the mobile robot 1 travels according to a setting, the mobile robot 1 receives a charging stand return signal or a tool separation signal in S420.

The traveling controller 113 controls the traveling unit 250 to move to the charging stand 40 in S430. Accordingly, the mobile robot 1 moves from a current position to the charging stand 40.

The mobile robot 1 moves to the charging stand 40 by a predetermined distance, and outputs guidance on mounting of the tool in S440.

The mobile robot 1 determines whether it is required to rotate in S450, and may rotate in S460 or may wait for a predetermined period of time at the position. Once the tool is mounted while waiting, the mobile robot 1 performs a predetermined operation in S520.

In the case where the tool is not mounted while waiting for a predetermined period of time in S480, the mobile robot 1 checks a residual quantity of a battery, and determines whether it is required to charge the battery in S490.

If the battery requires charging, the mobile robot 1 returns to the charging stand 40 in S510, charges the battery, and then performs a predetermined operation.

By contrast, if charging is not required, the mobile robot 1 returns to a traveling position at which the mobile robot 1 receives the tool separation signal, and performs a predetermined operation in S500.

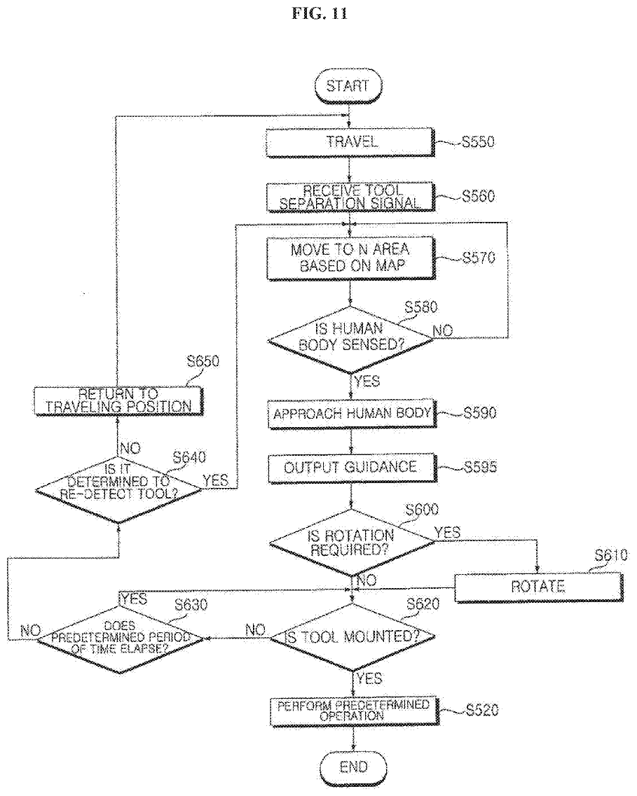

FIG. 11 is a flowchart illustrating a tool detecting method by using a map of a mobile robot and a controlling method thereof according to an embodiment of the present disclosure.

As illustrated in FIG. 11, the mobile robot 1 receives a tool separation signal from a charging stand in S560 while traveling. The mobile robot 1 determines a current position based on a pre-stored map, and sequentially moves to areas based on the current position in S570, to detect a tool or a human body in S580.

Upon sensing a human body while moving in an area, the mobile robot 1 approaches the sensed human body by a predetermined distance in S590. The obstacle recognizing unit 111 senses an obstacle, and if the obstacle is a human body, the traveling controller 113 controls the traveling unit 250 to move to the position by a predetermined distance.

Further, by distinguishing a specific user from a plurality of other users, the mobile robot 1 may determine that the specific user has the tool even when other human body is sensed. If the sensed human body is the specific user, the mobile robot 1 approaches the user, and if it is not, the mobile robot 1 may continue moving.

Upon approaching the human body, the mobile robot 1 outputs guidance on mounting of the tool in S595.

The mobile robot determines whether it is required to rotate in S600, and the mobile robot 1 rotates in S610 or waits for a predetermined period of time at the position. Once the tool is mounted while waiting, the mobile robot performs a predetermined operation in S660.

In the case where the tool is not mounted while waiting for a predetermined period of time in S630, the mobile robot 1 determines whether to re-detect the tool in S640. In the case where there is a remaining area to be detected among a plurality of areas, the mobile robot 1 determines that it is required to re-detect the area, and moves to an area n in S570.

Upon moving in all the areas for detection, when the tool is mounted onto the holder 50, the mobile robot 1 returns to a previous traveling position and performs a predetermined operation in S650.

Upon sensing a human body during re-detection, the mobile robot 1 approaches the human body and outputs guidance in S570 to S620 as described above, and when the tool is mounted, the mobile robot 1 performs a predetermined operation in S660.

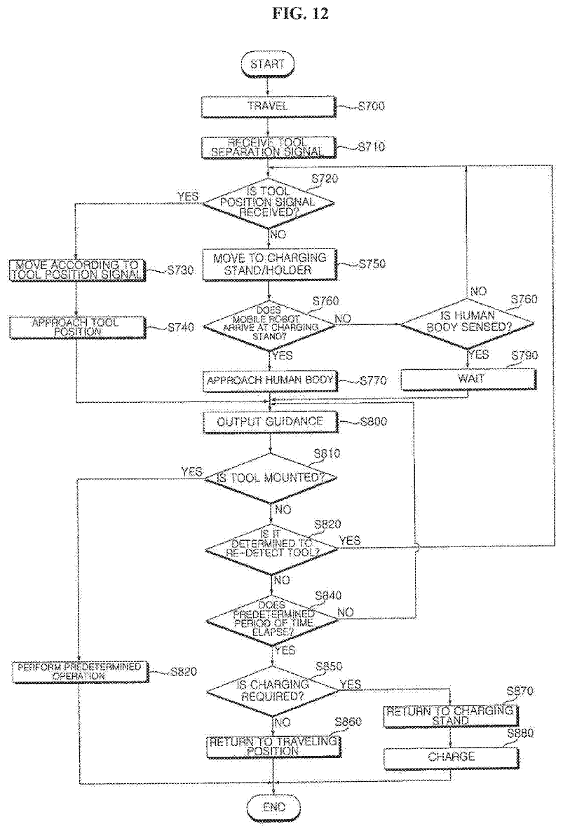

FIG. 12 is a flowchart illustrating a tool detecting method by using a position signal of a mobile robot and a controlling method thereof according to an embodiment of the present disclosure.

As illustrated in FIG. 12, the mobile robot 1 receives a tool separation signal while traveling in S710.

Upon receiving the tool separation signal, when the mobile robot 1 receives a tool position signal from the tool in S720, the mobile robot 1 tracks the tool position signal and moves to the position of the tool in S730. Based on the tool position signal, the mobile robot 1 moves to the position of the tool by a predetermined distance in S740.

Upon approaching the position of the tool, the mobile robot 1 outputs guidance on mounting of the tool in S800.

Once the tool is mounted in S810, the mobile robot 1 performs a predetermined operation in S820.

After the mobile robot 1 approaches the position of the tool, when the tool is not mounted in S810, the mobile robot determines whether to re-detect the tool in S820. During re-detection, the mobile robot 1 checks again whether the tool position signal is received in S720; and upon receiving the tool position signal, the mobile robot 1 moves again according to the received signal, to detect the position of the tool in S730 and S740.

Upon receiving the tool separation signal, when the tool position signal is not received, or the tool position signal is not received during re-detection, the mobile robot 1 moves to the charging stand 40 or to the holder 50 in S750.

Upon sensing the human body in S760 while moving to the charging stand 40, the mobile robot 1 approaches the human body by a predetermined distance in S770. Upon approaching the human body, the mobile robot 1 outputs guidance on mounting of the tool in S800.

Upon outputting the guidance, the mobile robot 1 waits for a predetermined period of time and senses whether the tool is mounted in S810, and when the tool is mounted while waiting, the mobile robot 1 performs a predetermined operation in S820.

While moving to the charging stand 40, when the mobile robot 1 senses the tool position signal before arriving at the charging stand 40, the mobile robot 1 r roves according to the tool position; and when the mobile robot 1 does not sense the tool position signal or a human body before arriving at the charging stand 40, the mobile robot 1 approaches the charging stand 40 by a predetermine distance and waits in S790.

The mobile robot 1 outputs guidance while waiting, and senses whether the tool is mounted while waiting for a predetermined period of time in S810. When the tool is mounted while waiting, the mobile robot 1 performs a predetermined operation in S820.

If the tool is not mounted while waiting for a predetermined period of time in S840, the mobile robot 1 may repeatedly re-detect the tool.

If the tool is not mounted during the predetermined period of time in S840, and the mobile robot 1 no longer re-detects the tool, the mobile robot 1 checks a residual quantity of a battery, and determines whether it is required to charge the battery in S850.

If charging is required, the mobile robot 1 returns to the charging stand 40 in S870, charges the battery in S880, and performs a predetermined operation.

If charging is not required, the mobile robot 1 returns to a previous traveling position at which the mobile robot receives the tool separation signal, and performs a predetermined operation in S860.

As described above, according to the present disclosure, when the tool becomes separated from the holder, the mobile robot automatically moves to a position to facilitate mounting of the tool, such that a user may easily mount the tool.

Once a user separates the tool, the mobile robot, which travels in another area, may move to the charging stand; or upon sensing a human body, the mobile robot approaches the sensed human body. Accordingly, the mobile robot may detect and move to the user without requiring the user to move, thereby enabling the user to mount the tool and designate an operation in a convenient manner.

While the present disclosure has been described herein with reference to the accompanying drawings, this disclosure is only illustrative of preferred embodiments of the present disclosure and is not intended to limit the present disclosure. Further, it will be apparent to those skilled in the art that various modifications and variations may be made without departing from the spirit and scope of the disclosure.

What is claimed is:

1. A mobile robot, comprising:
a main body which travels in an area;
a tool mounted at the main body to assist in cleaning;
a holder onto which the tool is held; and
a charging stand which supplies operating power to move the main body,
wherein when the tool becomes separated from the holder, upon receiving a tool separation signal from the charging stand, the main body moves to a position of the tool so that the tool is mounted at the main body.

2. The mobile robot of claim 1, wherein:
when the tool becomes separated from the holder, the holder transmits the tool separation signal to the charging stand;
when the tool is mounted, the tool transmits a mounting signal; and
upon receiving the tool separation signal, the charging stand transmits the tool separation signal to the main body.

3. The mobile robot of claim 1, wherein upon receiving the tool separation signal while a battery is charged at the charging station, the main body becomes separated from the charging stand and moves a predetermined distance.

4. The mobile robot of claim 1, wherein upon receiving the tool separation signal while traveling, the main body moves to the charging stand.

5. The mobile robot of claim 4, wherein upon sensing a human body while moving to the charging stand, the main body recognizes that the sensed human body has the tool, and approaches the human body.

6. The mobile robot of claim 5, wherein:
the main body determines whether the sensed human body is a registered user;
upon determining that the sensed human body is the user, the main body approaches the user; and
upon determining that the sensed human body is not the user, the main body continues moving.

7. The mobile robot of claim 1, wherein the tool comprises a communication module for transmitting a position signal,
wherein upon receiving a tool position signal from the user, the main body tracks the tool position signal, to move to a position of the tool.

8. The mobile robot of claim 1, wherein upon receiving the tool separation signal, the main body moves in areas sequentially based on a pre-stored map, to detect a user or a tool.

9. The mobile robot of claim 8, wherein the tool transmits a UWB signal as a position signal.

10. The mobile robot of claim 1, wherein upon approaching any one of a sensed human body, the tool, and the charging stand by a predetermined distance, the main body outputs guidance on mounting of the tool.

11. The mobile robot of claim 1, wherein the main body waits for a predetermined period of time to sense whether the tool is mounted,
wherein when the tool is mounted, the main body performs a predetermined operation, and when the tool is not mounted, the main body re-detects the tool or returns to a previous position.

12. The mobile robot of claim 1, wherein the main body comprises:
a detection unit configured to detect an obstacle in a traveling direction;
a communicator configured to receive a signal from the charging stand or the tool;
a data unit configured to store a plurality of image data and obstacle data, which are input from the detection unit; and
a controller configured to recognize an obstacle based on data input from the detection unit, and upon receiving through the communicator the tool separation signal from the charging stand or the tool position signal from the tool, configured to control traveling to move to the charging stand or the tool.

13. A controlling method of a mobile robot, the method comprising:
separating a tool, held onto a holder, from the holder;
transmitting a tool separation signal of the tool from the holder to a charging stand;
transmitting the tool separation signal from the charging stand to a main body of the mobile robot;
by the main body, receiving the tool separation signal; and
by the main body, moving to a position of the tool so that the tool is mounted at the main body.

14. The method of claim 13, further comprising upon receiving the tool separation signal while a battery is charged at the charging station, separating from the charging stand and moving a predetermined distance.

15. The method of claim 13, further comprising upon receiving the tool separation signal while traveling, moving to the charging stand.

16. The method of claim 13, further comprising:
upon sensing a human body while moving to the charging stand, recognizing that the sensed human body has the tool, and approaching the human body;
determining whether the sensed human body is a registered user; and
upon determining that the sensed human body is the user, approaching the user, and upon determining that the sensed human body is not the user, continuing moving.

17. The method of claim 13, further comprising:
upon receiving the tool separation signal, moving in a plurality of areas sequentially based on a pre-stored map; and
detecting a human body or the tool located in each area.

18. The method of claim 13, further comprising:
transmitting a tool position signal from the separated tool;
receiving the tool position signal; and
tracking the tool position signal, to move to a position of the tool.

19. The method of claim 13, further comprising:
approaching any one of a sensed human body, the tool, and the charging stand by a predetermined distance while the main body moves;
outputting guidance on mounting of the tool; and
waiting for a predetermined period of time and sensing whether the tool is mounted.

20. The method of claim 19, further comprising:
when the tool is mounted, performing a predetermined operation; and
when the tool is not mounted after a lapse of a predetermined time, re-detecting the tool or returning to a previous position.
